(19) United States
(12) Patent Application Publication
(10) Pub. No.: US 2026/0338354 A1
(43) Pub. Date: Oct. 29, 2026

(54) Light shading system having a shutter with independently driven rotation and translation, and stage light fixture

(71) Applicant: Guangzhou Haoyang Electronic Co., Ltd., Guangzhou (CN)

(72) Inventors: Weikai JIANG, Guangzhou (CN); Jun LUO, Guangzhou (CN); Zhiqiang CHEN, Guangzhou (CN); Renping YE, Guangzhou (CN)

(21) Appl. No.: 19/376,428

(22) Filed: Oct. 31, 2025

(30) Foreign Application Priority Data
Apr. 27, 2025 (CN) 202520815406.9

(51) Int. Cl. F21V 14/08; F21S 10/00; F21V 11/10; F21V 11/16; F21V 11/18; F21V 14/04; F21V 21/30; F21W 131/406

(52) U.S. Cl. CPC F21V 14/08; F21V 11/10; F21V 11/18; F21V 11/183; F21V 11/186; F21V 21/30; F21S 10/007; F21V 11/16; F21V 14/04; F21V 14/045; F21V 14/085; F21W 2131/406

(57) ABSTRACT

A light shading system includes a rotatable support driven by a support driving mechanism to rotate, at least two pairs of shutters arranged on the rotatable support, and a shutter driving mechanism for each shutter. The shutter driving mechanism includes an angle swing arm, a translation arm pivotally connected to the angle swing arm through a first pivot point and pivotally connected to the respective shutter through a fourth pivot point, an angle connecting rod pivotally connected to the angle swing arm through a second pivot point and pivotally connected to the respective shutter through a third pivot point, where a parallelogram is defined by the first pivot point, the second pivot point, the third pivot point, and the fourth pivot point, an angle driving motor coupled to the angle swing arm, and a translation driving motor configured to rotate the translation arm or the angle connecting rod.

### CROSS REFERENCE TO RELATED APPLICATIONS

The present application claims priority from Chinese Application No. CN 202520815406.9 filed on Apr. 27, 2025, all of which are hereby incorporated herein by reference.

### TECHNICAL FIELD

The present disclosure relates to the technical field of light beam shaping, and in particular, to a light shading system having a shutter with independently driven rotation and translation, and a stage light fixture.

### BACKGROUND

The stage light fixtures usually provide at least one shutter which is configured to switch into and out of the light path to shape the light beam, thereby achieving a variety of lighting effects. Generally, the shutter is required to switch into the light path at a certain preset rotation angle and translate in the light path at this preset rotation angle. For the purpose of this, the shutter is typically driven by two motors to achieve rotation and translation, in which the rotation angle and translation position would be interfered each other, that is the rotation of the shutter will change the translation position of the shutter and vice versa.

For example, CN 104 854 400 B, relating to an improved framing shutter system for a luminaire, involves two motors driving the shutters through a two-bar linkage pivotally connected thereto, with the shutters further constrained by a guide element to limit movement trajectory. In such way, during translation of the shutters, the two motors are required to constantly make fine adjustments to ensure the angle of the shutters unchanged. This needs quite complex control, and the shutters are inevitable to shake, especially in a case that the light beams are projected over a long distance, shaking becomes very noticeable, which significantly affects the viewing experience.

### SUMMARY

The present disclosure provides a light shading system having a shutter with independently driven rotation and translation, and a stage light fixture, which allows the shutter to switch into the light beam at a preset rotation angle and translate stably at this preset rotation angle.

One aspect of the present disclosure provides a light shading system, including a rotatable support having a rotation center, which is driven by a support driving mechanism to rotate; at least two pairs of shutters arranged on the rotatable support and rotatable along with the rotatable support; and a shutter driving mechanism for each shutter, which is configured for driving the respective shutter to rotate and translate, including an angle swing arm having a pivot end and a free end; a translation arm pivotally connected to the pivot end of the angle swing arm through a first pivot point which is stationary relative to the rotatable support and pivotally connected to the respective shutter through a fourth pivot point; an angle connecting rod pivotally connected to the free end of the angle swing arm through a second pivot point and pivotally connected to the respective shutter through a third pivot point, wherein a parallelogram is defined by the first pivot point, the second pivot point, the third pivot point, and the fourth pivot point; an angle driving motor coupled to the pivot end of the angle swing arm, which is configured to rotate the respective shutter through driving the angle swing arm to rotate around the first pivot point; and a translation driving motor, which is configured to translate the respective shutter through driving the translation arm to rotate around the first pivot point or driving the angle connecting rod to rotate around the second pivot point.

In the light shading system of the present disclosure, the shutter driving mechanism includes the angle driving motor for controlling rotation angles of the corresponding shutter and the translation driving motor for controlling translation position of the corresponding shutter. Due to the parallelogram defined by the pivot points of the angle swing arm, the angle connecting rod, the shutter, and the translation arm, if the angle swing arm is not driven to rotate by the angle driving motor, namely the direction defined by the first pivot point 411 and the second pivot point 412 remains unchanged, the direction defined by the third pivot point 310 and the fourth pivot point 320 will also remain unchanged, as opposite sides of the parallelogram always remain parallel. Accordingly, the angle position of the respective shutter keeps constant during translation driven by the translation driving motor, with the translation arm rotating around the first pivot point or with the angle connecting rod rotating around the second pivot point. In this case, the shutter will only translate under the drive of the translation driving motor without angel changed. If the translation arm is not driven by the translation driving motor to rotate, namely the position of the fourth pivot point is unchanged, or the angle connecting rod is not driven by the translation driving motor to rotate, namely the position of the third pivot point is unchanged, that is only the angle swing arm is driven by the angle driving motor to rotate, the respective shutter in this case only rotates along with the angle swing arm to change the rotation angle of the shutter while keeping its position unchanged.

Therefore, the control of the rotation angle and translation position of the shutters in the light shading system of the present embodiment is independent and would not interfere with each other. In simpler control, the shutter can be stably operated with less shaking or even without any shaking. In addition, since the angle driving motor is dynamically coupled to the pivot end of the angle swing arm, a possible power transmission component between the angle driving motor and the angle swing arm is eliminated, which effectively reduces the space occupied.

Due to the advantages of simple in structure and stable transmission, a connecting rod is used to transmit driving force from the driving motor in a preferable embodiment. In this embodiment, the translation driving motor is configured to drive the translation arm or the angle connecting rod to rotate through the connecting rod assembly.

As two-linkage structure offers accurate and controllable degrees of freedom, with each angle of the translation driving motor corresponding to each position of the shutter, the connecting rod assembly in a more preferable embodiment is designed into a two-linkage structure, which includes a translation swing arm fixedly connected to the rotating shaft of the translation driving motor, and a translation connecting rod with one end pivotally connected to the translation swing arm and the other end pivotally connected to the translation arm or the angle connecting rod. This design ensures a one-to-one corresponding relationship between the rotation angle of the translation driving motor and the shutter, which facilitates control.

In an advantageous embodiment of the present disclosure, in order to provide a wide range of rotation for the translation swing arm or the angle connecting rod, a middle part of the translation swing arm or the angle connecting rod is bent in a direction away from the rotation center of the rotatable support. This bending allows other components on the rotatable support to be avoided.

In a preferable embodiment of the present disclosure, the translation connecting rod is pivotally connected to the translation arm at a side of the fourth pivot point away from the first pivot point. This effectively avoids interference between the translation connecting rod and the angle connecting rod, thereby ensuring smooth operation of the shutter driving mechanism.

To reduce the whole length of the translation connecting rod and avoid too much moving space required due to excessive length, the translation arm in a more preferable embodiment is extended from the fourth pivot point, in a direction away from the rotation center of the rotatable support, to pivotally connected to the translation connecting rod. That is, the translation arm in this case is bent to the translation connecting rod. Such bending design also can avoid interference on the other components of the rotatable support.

In a bid to reduce moving space required by the connecting portion, the shutter may be extended from an end in a direction away from the rotation center of the rotatable support to form an elongated connecting portion, preferably having reduced width than the shutter. In this case, the third pivot point and the fourth pivot point are located on the connecting portion.

Additionally, a displacement limiting member may be further included for limiting displacement range of the respective shutter by restricting rotation of the translation swing arm. The limiting member can prevent excessive rotation of the translation swing arm, so as to avoid interference with the translation connecting rod or excessive included angle between the translation swing arm and the translation connecting rod, such as more than 180 degrees.

According to a preferable embodiment of the present disclosure, the angle swing arm is fixedly connected to a rotating shaft of the angle driving motor and the translation arm is pivotally connected to the rotating shaft of the angle driving motor. In this case the first pivot point (411) is located on a rotation axis of the rotating shaft of the angle driving motor. This configuration eliminates the need for the power transmission component between the angle driving motor and the angle swing arm, thereby further minimizing the space required.

In addition, to prevent interference between the angle connecting rod and the translation arm, the shutter driving mechanism in a preferable embodiment further includes an angle limiting member configured to limit rotation angle range of the respective shutter by restricting rotation of the angle swing arm.

As a focal point of the light beam is generally located near the central aperture in the application of the stage light fixture, according to a preferable embodiment of the present disclosure, two pairs of shutters are provided, each pair of shutters being respectively located on each side of a central plate having a central aperture. That is all the shutters are arranged as close as possible to the focal point of the light beam, so that each shutter can image clearly. In addition, the two pairs of shutters are arranged around the central aperture, so that the light beam can be shaped by the shutters from multiple directions.

More preferably, the shutters in each pair of shutters may be arranged opposite to each other and spaced apart by a separator, and one pair of shutters may be arranged perpendicularly relative to another pair. This can prevent interference between adjacent shutters and allow the light beam to be framed into symmetrical shapes.

Furthermore, a bottom plate (130) located below the lowest shutter (300) and a upper plate (140) located above the uppermost shutter (300) may be further included, and each of the separator (120), the bottom plate (130) and/or the upper plate (140) may be provided with an avoidance notch (141) corresponding to the angle connecting rod (430) or the translation arm (420). The avoidance notch can provide more moving space for the movement of the angle connecting rod or the translation arm, thereby increasing the rotation angle range and displacement range of the shutters.

Another aspect of the present disclosure provides a stage light fixture, including a light head for projecting a light beam, a support arm for supporting rotation of the light head, a base for supporting rotation of the support arm, and further including the light shading system in ane case mentioned above, which is located inside the light head for selectively switching in/out of the light beam to shape the light beam.

Further advantages, features and potential applications of the present invention may be gathered from the description which follows, in conjunction with the embodiments illustrated in the drawings.

### BRIEF DESCRIPTION OF THE DRAWINGS

FIG. 1 is an exploded structural schematic diagram of a light shading system according to an embodiment of the present disclosure;

FIG. 2 is a perspective view of a light shading system according to an embodiment of the present disclosure, only showing two pairs of shutters and corresponding shutter driving mechanism;

FIG. 3 is a perspective view showing one shutter and the shutter driving mechanism thereof;

FIG. 4 is an exploded view of FIG. 1, with a support driving mechanism and a rotatable support removed; and

FIG. 5 is a perspective view of a stage light fixture according to an embodiment of the present disclosure.

### DETAILED DESCRIPTION OF THE EMBODIMENTS

The accompanying drawings are merely for purposes of illustration and should not be understood as limitation of the patent; in order to better illustrate the embodiment, some parts in the accompanying drawings may be omitted, enlarged or reduced, and do not represent the actual size of a product; and it is understandable to those skilled in the art that some well-known structures and descriptions thereof may be omitted in the accompanying drawings. The positional relationships described in the accompanying drawings are merely for purposes of illustration and should not be understood as limitation of the patent.

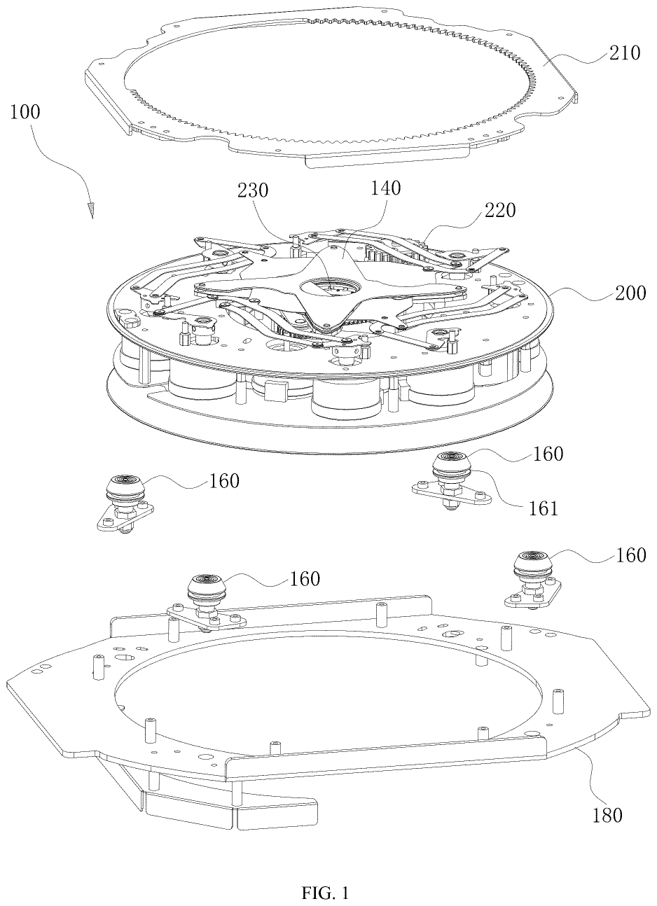

FIGS. 1 to 4 provide a light shading system 100 according to an embodiment of the present disclosure, including a rotatable support 200 driven by a support driving mechanism, at least two pairs of shutters 300 arranged on the rotatable support 200 and rotatable along with the rotatable support 200, and a shutter driving mechanism for each shutter, which is configured to drive the corresponding shutter to rotate and translate. The shutter driving mechanism includes an angle swing arm 410 for driving corresponding shutter to rotate, a translation arm 420 connected to the pivot end of the angle swing arm 410, where the angle swing arm 410 and the translation arm 420 have a common rotation center which defines a first pivot point 411 that remains stationary relative to the rotatable support 200, and an angle connecting rod 430 pivotally connected to the second pivot point 412 on the free end of the angle swing arm 410. The angle connecting rod 430 and the translation arm 420 are respectively pivotally connected to the respective shutter 300 through a third pivot point 310 and a fourth pivot point 320. The first pivot point 411, the second pivot point 412, the third pivot point 310, and the fourth pivot point 320 in the present embodiment form a parallelogram. The shutter driving mechanism further includes an angle driving motor 400 coupled to the pivot end of the angle swing arm 410 to drive the angle swing arm 410 to rotate around the first pivot point 411, and a translation driving motor 500 configured to drive the translation arm 420 to rotate around the first pivot point 411 or to drive the angle connecting rod 430 to rotate around the second pivot point 412.

In the present embodiment, the shutter driving mechanism of the light shading system 100 includes the angle driving motor 400 that controls rotation angles of the corresponding shutter 300 and the translation driving motor 500 that controls translation position of the corresponding shutter 300. Due to the parallelogram defined by the pivot points of the angle swing arm 410, the angle connecting rod 430, the shutter 300, and the translation arm 420, if the angle swing arm 410 is not driven to rotate by the angle driving motor 400, namely the direction defined by the first pivot point 411 and the second pivot point 412 remains unchanged, the direction defined by the third pivot point 310 and the fourth pivot point 320 will also remain unchanged, as opposite sides of the parallelogram always remain parallel. As a result, the angle position of the shutter remains constant, when the translation driving motor 500 drives the shutter 300 to translate, with the translation arm 420 rotating around the first pivot point 411 or with the angle connecting rod 430 rotating around the second pivot point 412. In this case, the shutter 300 will only translate under the drive of the translation driving motor 500. If the translation arm 420 is not driven by the translation driving motor 500 to rotate, namely the position of the fourth pivot point 320 is unchanged, or the angle connecting rod 430 is not driven by the translation driving motor 500 to rotate, namely the position of the third pivot point 310 is unchanged, that is only the angle swing arm 410 is driven by the angle driving motor 400 to rotate, in this case the shutter 300 rotates along with the angle swing arm 410 to change the rotation angle of the shutter 300 while keeping its position unchanged.

Accordingly, the control of the rotation angle and translation position of the shutters 300 in the light shading system 100 of the present embodiment is independent and would not interfere each other. In simpler control, the shutter 300 can be stably operated with less shaking or even without any shaking. In addition, since the angle driving motor 400 is directedly coupled to the pivot end of the angle swing arm 410, a possible power transmission component between the angle driving motor 400 and the angle swing arm 410 can be eliminated, which effectively reduces the space occupied.

In operation, the shutter 300 can be firstly adjusted to the preset rotation angle outside the light beams by the angle driving motor 400, and then driven to translate to the light beams by the translation driving motor 500. As long as the angle driving motor 400 remains stationary, the shutter 300 can translate within the light beams at the preset rotation.

In this embodiment, the angle driving motor 400 directly or indirectly acts on the pivot end of the angle swing arm 410, and the free end of the angle swing arm 410 is in a non-transmission connection state. The movement trajectory of the free end of the angle swing arm 410 therefore is completely determined by the driving torque received at the pivot end and the mechanical characteristics of the angle swing arm 410 itself. No any power transmission mechanism or energy input interface is provided between the free end and the pivot end of the angle swing arm 410.

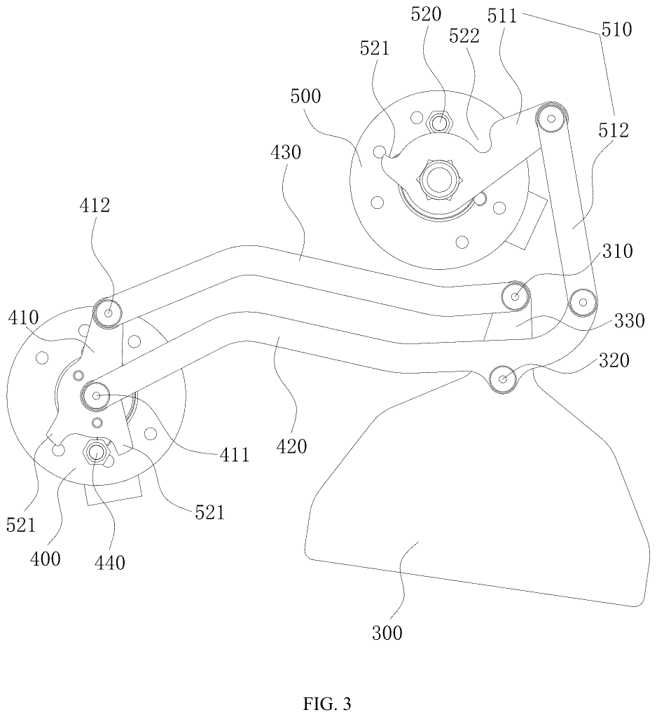

As shown in FIG. 3, the translation driving motor 500 drives the translation arm 420 or the angle connecting rod 430 to rotate through a connecting rod assembly 510, as the connecting rod assembly 510 has a simple structure and provides stable transmission.

The connecting rod assembly 510 may be in a two-linkage structure, or a three-linkage structure or more. However, for more connecting rods, such as two or more, more constraints are required to limit the degrees of freedom, so that each rotation angle of the translation driving motor 500 corresponds to each position of the shutter 300, that is, the rotation angle of the translation driving motor 500 and the position of the respective shutter 300 is in a one-to-one correspondence for accurate control.

In this embodiment, the connecting rod assembly 510 is in a two-linkage structure, including a translation swing arm 511 fixedly connected to the rotating shaft of the translation driving motor 500, and a translation connecting rod 512 with one end pivotally connected to the translation swing arm 511 and the other end pivotally connected to the translation arm 420 or the angle connecting rod 430. Such two-linkage structure provides accurate and controllable degrees of freedom, and each rotation angle of the translation driving motor 500 corresponds to each position of the corresponding shutter 300.

In the present embodiment, the angle driving motor 400 and the translation driving motor 500 are both fixed on one side of the rotatable support 200, while the angle swing arm 410, the angle connecting rod 430, the shutter 300, the translation arm 420, the translation swing arm 511, and the translation connecting rod 512 are all located on the other side of the rotatable support 200.

In order to avoid other components on the rotatable support 200, a middle part of the translation swing arm 511 or the angle connecting rod 430 is bent in a direction away from the rotation center 230 of the rotatable support 200. This bending design also allows the translation swing arm 511 or the angle connecting rod 430 to rotate in a wide range.

Generally, the rotation center 230 of the rotatable support 200 is located on the center line of the light beam.

Preferably, the angle connecting rod 430 is located on a side of the translation arm 420 away from the rotation center 230 of the rotatable support 200.

In this embodiment, the translation connecting rod 512 is pivotally connected to the translation arm 420, and the pivot point thereof is located on a side of the fourth pivot point 320 away from the first pivot point 411. This effectively avoids the interference from the translation connecting rod 512 and the angle connecting rod 430, ensuring smooth operation of the shutter driving mechanism.

The end of the translation arm 420, pivotally connected to the translation connecting rod 512, is bent in a direction away from the rotation center 230 of the rotatable support 200, with the fourth pivot point 320 located between the first pivot point 411and the pivot point between the translation arm 420 and the translation connecting rod. This can reduce the length of the translation connecting rod 512, avoid wasting too much moving space due to excessive length, and also provides avoidance space for other components on the rotatable support 200.

In this embodiment, the translation swing arm 511 extends from the translation driving motor 500 in a direction away from the angle driving motor 400 to pivotally connect with the translation connecting rod 512.

The shutter 300 extends in a direction away from the rotation center 230 of the rotatable support 200 to form an elongated connecting portion 330 with smaller width than the shutter 300, and the third pivot point 310 and the fourth pivot point 320 are located on the connecting portion 330. With the configuration of the elongated connecting portion 330 pivotally connected with the angle connecting rod 430 and the translation arm 420, less range of moving space occupied by the connecting portion 330 is required during rotation.

Preferably, the connecting portion 330 and the shutter 300 are on the same plane, which can be cut/press formed integrally.

A displacement limiting member 520 is further provided in the present embodiment, which is configured to restrict the rotation of the translation swing arm 511 so as to limit maximum displacement and minimum displacement of the shutter 300. The displacement limiting member 520 can prevent the translation swing arm 511 from excessive rotation, which could cause interference with the translation connecting rod 512 or the included angle between the translation swing arm 511 and the translation connecting rod 512 to exceed 180 degrees.

Furthermore, the translation swing arm 511 is provided with a limiting protrusion 521 and a limiting groove 522 that respectively cooperate with the displacement limiting member 520 to restrict the maximum rotation angle and minimum rotation angle of the translation swing arm 511, thereby limiting the maximum displacement and minimum displacement of the shutter 300.

In this embodiment, the displacement limiting member 520 is a screw arranged on the rotatable support 200.

According to the present embodiment, the angle swing arm 410 is fixedly connected to the rotating shaft of the angle driving motor 400, the translation arm 420 is pivotally connected to the rotating shaft of the angle driving motor 400, and the first pivot point 411 is located on the rotation axis of the rotating shaft of the angle driving motor 400. This eliminates the power transmission component between the angle driving motor 400 and the angle swing arm 410, thereby minimizing the space required.

In order to prevent interference between the angle connecting rod 430 and the translation arm 420, an angle limiting member 440 is further required to restrict the rotation of the angle swing arm 410 so as to limit the maximum angles and the minimum angles of the shutter 300.

Furthermore, the angle swing arm 410 is also provided with two limiting protrusions 441 that cooperate with the angle limiting member 440 to restrict the maximum rotation angle and minimum rotation angle of the angle swing arm 410, thereby limiting the maximum rotation angle and minimum rotation angle of the shutter 300.

In this embodiment, the angle limiting member 440 is a screw arranged on the rotatable support 200.

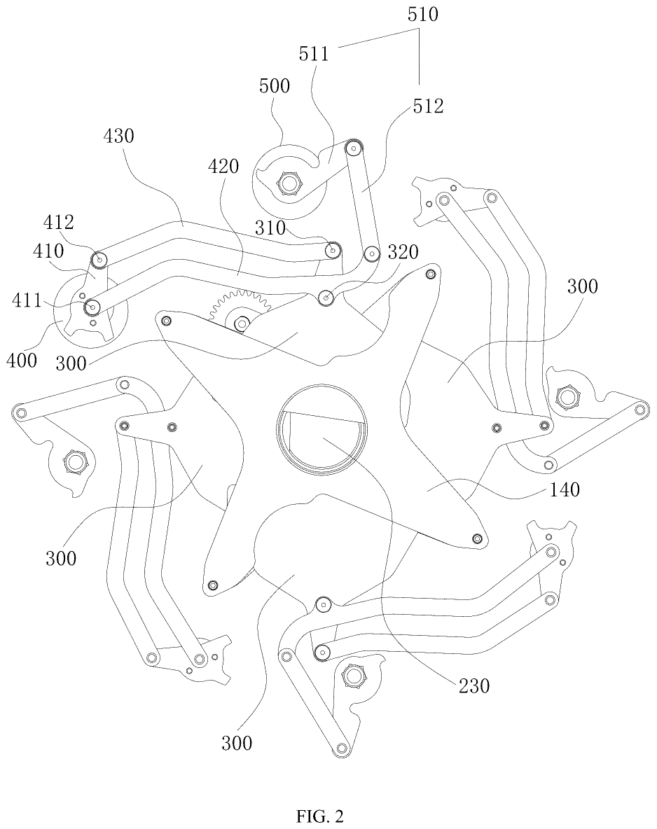

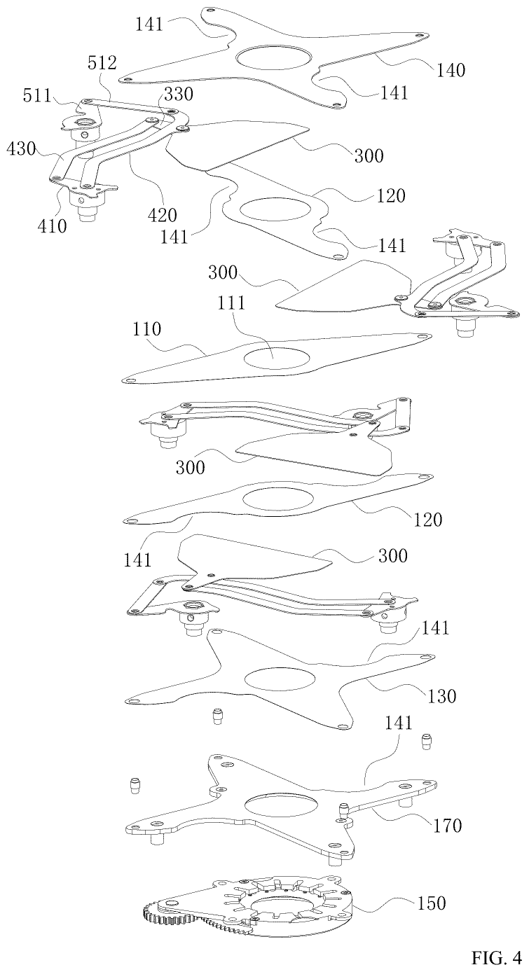

In combination with FIGS. 2 and 4, two pairs of shutters 300 are included, which are respectively located on both sides of a central plate 110 with a central aperture 111, and the two pairs of shutters 300 are arranged around the central aperture 111. In use, a focal point of the light beam is generally located near the central aperture 111. With the two pairs of shutters 300 arranged on both sides of the central plate 110, all the shutters 300 can be as close as possible to the focal point of the light beam, so that each shutter can image clearly. Furthermore, with the two pairs of shutters 300 arranged around the central aperture 111, the light beam can be shaped by the shutters 300 from multiple directions.

In addition, the shutters 300 in each pair of shutters 300 are arranged opposite to each other and spaced apart by a separator 120. In such configuration, each pair of shutters 300 can be switched into or out of the light beam from opposite sides, and adjacent shutters 300 can be prevented from interfering with each other by the separator 120. Furthermore, the two pairs of shutters 300 are arranged to be perpendicular to each other, which allows the light beam to be shaped by the system into symmetrical shapes. In this case, the two pairs of shutters 300, namely four shutters 300, are positioned one atop the other, with one pair perpendicular to the other pair and two shutters 300 in the same pair opposite to each other.

A bottom plate 130 located below the lowest shutter 300 and an upper plate 140 located above the uppermost shutter 300 are further provided in this embodiment. Each of the separator 120, the bottom plate 130 and/or the upper plate 140 is provided with an avoidance notch 121, 131, 141 corresponding to the angle connecting rod 430 or the translation arm 420. The avoidance notch 121, 131, 141 can provide a space for the movement of the angle connecting rod 430 or the translation arm 420, increasing moving range therefor, thereby expanding the rotation angle range and displacement range of the shutters 300.

Preferably the avoidance notch 121, 131, 141 is provided corresponding to the one of the angle connecting rod 430 and the translation arm 420 that is relatively closer to the rotation center 230 of the rotatable support 200. In this embodiment, the translation arm 420 is closer to the rotation center 230 of the rotatable support 200.

In this embodiment, the bottom plate 130 is connected to the upper plate 140, and the central plate 110 and the separator 120 are fixed onto the bottom plate 130 or the upper plate 140 to form a whole which is fixed on the mounting plate 170.

The mounting plate 170 is also formed with an avoidance notch 171 corresponding to the angle connecting rod 430 or the translation arm 420.

An aperture assembly 150 may be further arranged on the rotatable support 200 in this embodiment.

Referring back to FIG. 1, the support driving mechanism in this embodiment includes a stationary arc-shaped gear rack 210 and a frame driving motor arranged on the rotatable support 200. A drive gear 220 is fixedly connected to the rotating shaft of the frame driving motor, and the drive gear 220 is meshed with the arc-shaped gear rack 210.

A supporting plate 180 is further provided, on which a plurality of supporting wheels 160 are provided for supporting rotation of the rotatable support 200. Each supporting wheel 160 is formed with a clamping groove 161. The rotatable support 200 is clamped in the clamping grooves 161 of the plurality of supporting wheels 160. Under driving of the frame driving motor, the rotatable support 200 rotates along the supporting wheels 160 with the cooperation of the drive gear 220 and the gear rack 210.

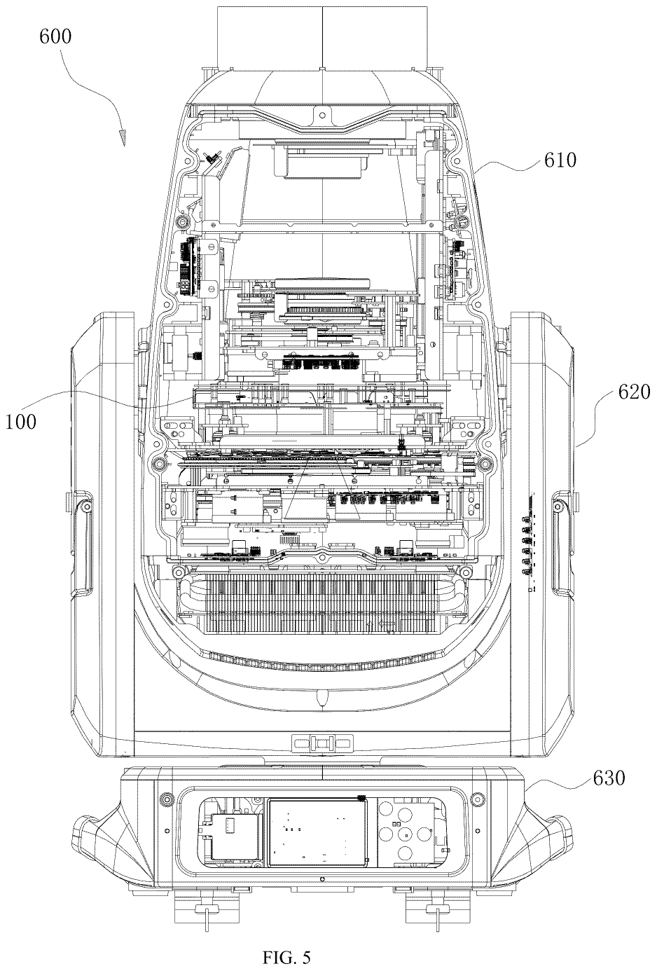

FIG. 5 provides a stage light fixture 600, including a light head 610 for emitting a light beam, a support arm 620 for supporting rotation of the light head 610, a base 630 for supporting rotation of the arm 620, and further including the light shading system 100 in any embodiment mentioned above. The light shading system 100 is located inside the light head 610 to selectively switch in/out of the light beams for shaping. With the support arm 620 and the base 630, the light beams emitted by the light head 610 and shaped by the light shading system 100 can be projected in any angle.

Obviously, the above-mentioned embodiments of the present disclosure are merely examples provided to clearly illustrate the present disclosure, and are not intended to limit the implementations of the present disclosure. For those of ordinary skill in the art, other variations or modifications in different forms may be made on the basis of the above description. It is unnecessary and impossible to exhaust all the implementations herein. Any modifications, equivalent substitutions, or improvements made within the spirit and principles of the present disclosure shall fall within the protection scope of the claims of the present disclosure.

What's claimed is:

1. A light shading system (100), comprising:
a rotatable support (200) having a rotation center (230), which is driven by a support driving mechanism to rotate;
at least two pairs of shutters (300) arranged on the rotatable support (200) and rotatable along with the rotatable support (200); and
a shutter driving mechanism for each shutter, which is configured for driving the respective shutter (300) to rotate and translate, comprising:
an angle swing arm (410) having a pivot end and a free end;
a translation arm (420), which is pivotally connected to the pivot end of the angle swing arm (410) through a first pivot point (411) which is stationary relative to the rotatable support (200) and pivotally connected to the respective shutter (300) through a fourth pivot point (320);
an angle connecting rod (430), which is pivotally connected to the free end of the angle swing arm (410) through a second pivot point (412) and pivotally connected to the respective shutter (300) through a third pivot point (310), wherein a parallelogram is defined by the first pivot point (411), the second pivot point (412), the third pivot point (310), and the fourth pivot point (320);
an angle driving motor (400) coupled to the pivot end of the angle swing arm (410), which is configured to rotate the respective shutter (300) through driving the angle swing arm (410) to rotate around the first pivot point (411); and
a translation driving motor (500), which is configured to translate the respective shutter (300) through driving the translation arm (420) to rotate around the first pivot point (411) or driving the angle connecting rod (430) to rotate around the second pivot point (412).

2. The light shading system (100) according to claim 1, wherein the translation driving motor (500) is configured to drive the translation arm (420) or the angle connecting rod (430) to rotate through a connecting rod assembly (510).

3. The light shading system (100) according to claim 2, wherein the connecting rod assembly (510) comprises a translation swing arm (511) fixedly connected to a rotating shaft of the translation driving motor (500), and a translation connecting rod (512) with one end pivotally connected to the translation swing arm (511) and the other end pivotally connected to the translation arm (420) or the angle connecting rod (430).

4. The light shading system (100) according to claim 3, wherein a middle part of the translation swing arm (511) or the angle connecting rod (430) is bent in a direction away from the rotation center (230) of the rotatable support (200).

5. The light shading system (100) according to claim 3, wherein the translation connecting rod (512) is pivotally connected to the translation arm (420) at a side of the fourth pivot point (320) away from the first pivot point (411).

6. The light shading system (100) according to claim 5, wherein the translation arm (420) is extended from the fourth pivot point (320), in a direction away from the rotation center (230) of the rotatable support (200), to pivotally connected to the translation connecting rod (512).

7. The light shading system (100) according to claim 1, wherein the shutter (300) is extended from an end in a direction away from the rotation center (230) of the rotatable support (200) to form an elongated connecting portion (330) with, and the third pivot point (310) and the fourth pivot point (320) are located on the connecting portion (330).

8. The light shading system (100) according to claim 3, wherein the shutter driving mechanism further comprises a displacement limiting member (520) configured to limit a maximum displacement and a minimum displacement of the respective shutter (300) by restricting rotation of the translation arm (420).

9. The light shading system (100) according to claim 1, wherein the angle swing arm (410) is fixedly connected to a rotating shaft of the angle driving motor (400) and the translation arm (420) is pivotally connected to the rotating shaft of the angle driving motor (400), in this case the first pivot point (411) is located on a rotation axis of the rotating shaft of the angle driving motor (400).

10. The light shading system (100) according to claim 1, wherein the shutter driving mechanism further comprises an angle limiting member (440) configured to limit a maximum rotation angle and a minimum rotation angle of the respective shutter (300) by restricting rotation of the angle swing arm (410).

11. The light shading system (100) according to claim 1, wherein two pairs of shutters (300) are provided, each pair of shutters (300) being respectively located on each side of a central plate (110) having a central aperture (111), and the two pairs of shutters (300) are arranged around the central aperture (111).

12. The light shading system (100) according to claim 11, wherein the shutters in each pair of shutters (300) are arranged opposite to each other and are spaced apart by a separator (120), and one pair of shutters are arranged perpendicularly relative to another pair.

13. The light shading system (100) according to claim 12, further comprising a bottom plate (130) located below the lowest shutter (300) and a upper plate (140) located above the uppermost shutter (300), and each of the separator (120), the bottom plate (130) and/or the upper plate (140) is provided with an avoidance notch (121, 131, 141) corresponding to the angle connecting rod (430) or the translation arm (420).

14. A stage light fixture, comprising a light head (610) for projecting a light beam, a support arm (620) for supporting rotation of the light head (610), a base (630) for supporting rotation of the support arm (620), and further comprising the light shading system (100) according to claim 1, which is located inside the light head (610) for selectively switching in/out of the light beam to shape the light beam.
